(19) United States
(12) Patent Application Publication
(10) Pub. No.: US 2023/0349428 A1
(43) Pub. Date: Nov. 2, 2023

(54) DOUBLE CLUTCH FOR AUTOMATIVE APPLICATIONS

(71) Applicant: MAGNA CLOSURES INC., Newmarket (CA)

(72) Inventors: Fabio TERMINE, Livorno (IT); Francesco BIASCI, Stagno (IT)

(21) Appl. No.: 18/137,781

(22) Filed: Apr. 21, 2023

Related U.S. Application Data
(60) Provisional application No. 63/337,379, filed on May 2, 2022.

(51) Int. Cl. F16D 41/16; E05F 15/622

(52) U.S. Cl. CPC F16D 41/16; E05F 15/622; E05Y 2201/216; E05Y 2201/26; E05Y 2201/266; E05Y 2201/434; E05Y 2201/702; E05Y 2800/406; E05Y 2900/546

(57) ABSTRACT

A clutch mechanism comprising: a first connection for coupling the clutch mechanism to a motor shaft; a second connection for coupling the clutch mechanism to a driven element; a ratchet having a plurality of notches; a pawl body having pivotally mounted thereon a plurality of pawls; each of the plurality of pawls having a respective lobe for engaging with a respective one of the plurality of notches; and one or more resilient elements for biasing the plurality of pawls into engagement with the plurality of notches; wherein a first set of the plurality of pawls inhibits decoupling of the pawl body from the ratchet in a first rotation direction and a second set of the plurality of pawls inhibits decoupling of the pawl body from the ratchet in a second rotation direction, such that the second rotation direction is opposite to the first rotation direction.

### FIELD

The present disclosure relates to actuation of a vehicle shaft actuation, in particular, for a spindle.

### BACKGROUND

A typical motor vehicle door is mounted in a door frame on the vehicle and is movable between open and closed positions. Usually the door is held in a closed position by the latching engagement between a spring-biased ratchet pivotally mounted inside the door latch and a U-shaped striker secured to the door frame. The ratchet is most often spring-biased toward the unlatched position to release the striker and is maintained in the latched position to hold the striker by a spring-biased pawl or other mechanical structure. The ratchet cannot pivot to release the striker until the pawl is moved.

The majority of these door latches are exclusively manually operated both to unlatch the door and to relatch the door. Typically, the manual release handles are provided on the inside and outside of the door to release the ratchet from the striker by moving the pawl so that the door can be opened. The door is closed and relatched by manually pivoting the door so that the ratchet impacts the striker with sufficient force to pivot the ratchet to the latched position against the spring force exerted by the ratchet spring.

An automatic opening/closing actuator of an automobile door is an important part for door opening and closing, including bi-directional operation of an actuated spindle mechanism. With the development of technical conditions, more and more medium and high-grade automobiles are equipped with automatic opening/closing actuators of automobile doors, such as a sport utility vehicle (SUV) power liftgate, power side doors provided on an electric trunk of a car and a high-grade automobile, a scissor door, and a gull-wing door. The automatic opening/closing actuator of the automobile door generally converts the rotary motion of a drive motor into the reciprocating linear motion of an actuator through the thread transmission between a lead screw and a lead screw nut, as involved in the spindle mechanism. Additionally, the lead screw nut is connected to a sleeve. Therefore, the sleeve to which the lead screw nut is connected is a core component of the automatic opening/closing actuator of the automobile door.

Further, current actuated spindle mechanisms can encounter difficult situations when the associated closure panel is somehow blocked or otherwise hindered from operating in a full range of travel as expected by the automated system. For example, a person who blocks or otherwise manually interrupts the automated operation of the closure panel, or the unexpected presence of a foreign object inhibiting opening or closure of the closure panel can result in undesirable damage to the spindle, as the motor (of the actuator coupled to the spindle) will continue to try to rotate the spindle even when travel of the closure panel is unexpectedly halted.

### SUMMARY

An object of the present disclosure is to provide a clutch mechanism to obviate or mitigate at least one of the above presented disadvantages.

An aspect provided is a clutch mechanism comprising: a first connection for coupling the clutch mechanism to a motor shaft; a second connection for coupling the clutch mechanism to a driven element; a ratchet having a plurality of notches; a pawl body having pivotally mounted thereon a plurality of pawls; each of the plurality of pawls having a respective lobe for engaging with a respective one of the plurality of notches; and one or more resilient elements for biasing the plurality of pawls into engagement with the plurality of notches; wherein a first set of the plurality of pawls inhibits decoupling of the pawl body from the ratchet in a first rotation direction and a second set of the plurality of pawls inhibits decoupling of the pawl body from the ratchet in a second rotation direction, such that the second rotation direction is opposite to the first rotation direction.

A further aspect provided is operating a clutch, the method comprising the steps of: coupling the clutch mechanism to a motor shaft; coupling the clutch mechanism to a driven element; inhibiting decoupling of a pawl body from a ratchet in a first rotation direction by a first set of a plurality of pawls; inhibiting decoupling of the pawl body from the ratchet in a second rotation direction, such that the second rotation direction is opposite to the first rotation direction.

A further aspect provided is applying a force between the respective lobe and the respective one of the notches in order to overcome friction present between the respective lobe and the respective one of the notches, whereby relative movement between the ratchet and the pawl body is facilitated.

A further aspect is a spindle mechanism for a motor vehicle, the spindle mechanism comprising: an extension member having an extended position and a retracted position; a motor having a motor shaft, the motor for moving the extension member between an extended position and the retracted position; a clutch mechanism positioned between the extension member and the motor, the clutch mechanism comprising: a first connection coupling the clutch mechanism to a motor shaft; a second connection for coupling the clutch mechanism to the extension member; a first cam surface operably coupled to the one of the first connection and the second connection; a second cam surface operably coupled to the other one of the first connection and the second connection; wherein the first cam surface and the second cam surface are configured such that the first cam surface and the second cam surface remain in engagement when a torque applied to one of the first connection and second connection is below a predetermined torque value, and the first cam surface and the second cam surface are configured to disengage when a torque applied to one of the first connection and second connection is above the predetermined torque value.

Further aspects provided are: static friction between the first cam surface and the second cam surface inhibits disengagement there between when the torque is below the predetermined torque value; an induced shock to the spindle causes the torque to be above the predetermined torque value and the static friction changes to sliding friction to facilitate disengagement between the first cam surface and the second cam surface; the induced shock is a force provided as the torque caused by the presence of a foreign object blocking travel of closure panel connected to the spindle mechanism; one of the first cam surface and the second cam surface is provided on a notch of the clutch mechanism; and the first cam surface is on a lobe rotational coupled to the clutch mechanism and the second cam surface is a notch of the clutch mechanism, such that the lobe is positioned adjacent to the notch such that the first cam surface and the second cam surface are facing one another.

A still further aspect provided is a method of operating a clutch, the method comprising the steps of: coupling the clutch mechanism to a motor shaft; coupling the clutch mechanism to a driven element; inhibiting decoupling of a pawl body from a ratchet in a first rotation direction by a first set of a plurality of pawls; inhibiting decoupling of the pawl body from the ratchet in a second rotation direction, such that the second rotation direction is opposite to the first rotation direction.

Still further aspects provided are: the ratchet has a plurality of notches, the pawl body (has pivotally mounted thereon the plurality of pawls, each of the plurality of pawls has a respective lobe for engaging with a respective one of the plurality of notches, and one or more resilient elements bias the plurality of pawls into engagement with the plurality of notches; and applying a force between the respective lobe and the respective one of the notches in order to overcome friction present between the respective lobe and the respective one of the notches, whereby relative movement between the ratchet and the pawl body is facilitated.

In a further provided aspect: a spindle mechanism for a motor vehicle, the spindle mechanism including an extension member having an extended position and a retracted position, a motor having a motor shaft, the motor for moving the extension member between an extended position and the retracted position, a clutch mechanism positioned between the extension member and the motor, wherein the clutch mechanism comprises a fully engaged state, a partially engaged state, and a fully disengaged state, wherein the torque required to transition the clutch mechanism from the fully engaged state to the fully disengaged state is higher than the torque required to transition the clutch mechanism from the partially engaged state to the fully disengaged state.

### BRIEF DESCRIPTION OF DRAWINGS

The foregoing and other aspects will be more readily appreciated having reference to the drawings, wherein:

FIG. 1 is perspective view of a vehicle having a closure panel;

FIG. 2 is further embodiment of the closure panel of FIG. 1;

FIG. 3 is a cross sectional view of an embodiment of the example linear actuator of FIG. 1;

FIGS. 4a, 4b are perspective views of an example embodiment of a linear actuator of the vehicle of FIG. 1;

FIG. 5 is an exterior structure view of a clutch mechanism within the actuator of the vehicles of FIGS. 1 and 2;

FIG. 6 is an interior structure view of the clutch mechanism within the actuator of the vehicles of FIGS. 1 and 2;

FIG. 7 is a further view of the actuator of FIG. 5;

FIG. 8 is an example interior view of the clutch mechanism of FIG. 5;

FIG. 9 is a first example operational example of the clutch mechanism of FIG. 8;

FIG. 10 is a second example operational example of the clutch mechanism of FIG. 8;

FIG. 11 is a third example operational example of the clutch mechanism of FIG. 8;

FIG. 12 is an example block diagram operation of the linear actuator of FIGS. 1 and 2;

FIG. 13 is another possible configuration of clutch mechanism of FIG. 8, shown in a fully engaged state according to aspects of the present disclosure;

FIG. 14 is the clutch mechanism of FIG. 13 shown in a partially disengaged state;

FIG. 15 is a graph illustrating the slip torque values of a clutch mechanism configured as a symmetrical clutch; and

FIG. 16 is a graph illustrating the slip torque values of a clutch mechanism configured as an asymmetrical clutch mechanism.

### DETAILED DESCRIPTION

The present disclosure is further described below in detail in conjunction with drawings and embodiments. It is to be understood that the embodiments set forth below are intended to merely illustrate the present disclosure and not to limit the present disclosure. It is to be noted that to facilitate description, merely part, not all, of structures related to the present disclosure are illustrated in the drawings.

In the description of the present disclosure, unless otherwise expressly specified and limited, the term “connected to each other”, “connected”, or “fixed” is to be construed in a broad sense, for example, as fixedly connected, detachably connected, or integrated; mechanically connected or electrically connected; directly connected to each other or indirectly connected to each other via an intermediary; or internally connected or an interactional relationship between two components. For those of ordinary skill in the art, specific meanings of the preceding terms in the present disclosure may be understood based on specific situations.

In the present disclosure, unless otherwise expressly specified and limited, when a first feature is described as “on” or “below” a second feature, the first feature and the second feature may be in direct contact or be in contact via another feature between the two features instead of being in direct contact. Moreover, when the first feature is described as “on”, “above” or “over” the second feature, the first feature is right on, above or over the second feature, the first feature is obliquely on, above or over the second feature, or the first feature is simply at a higher level than the second feature. When the first feature is described as “under”, “below” or “underneath” the second feature, the first feature is right under, below or underneath the second feature, the first feature is obliquely under, below or underneath the second feature, or the first feature is simply at a lower level than the second feature.

In the description of the embodiment, the orientations or position relations indicated by terms such as “on”, “below”, “right” and the like are based on the orientations or position relations shown in the drawings. These orientations or position relations are intended merely to facilitate and simplify the description of the present disclosure, and not to indicate or imply that a device or element referred to must have such specific orientations or must be configured or operated in such specific orientations. Therefore, these orientations or position relations are not to be construed as limiting the present disclosure. In addition, the terms “first” and “second” are used merely to distinguish between descriptions and have no special meaning.

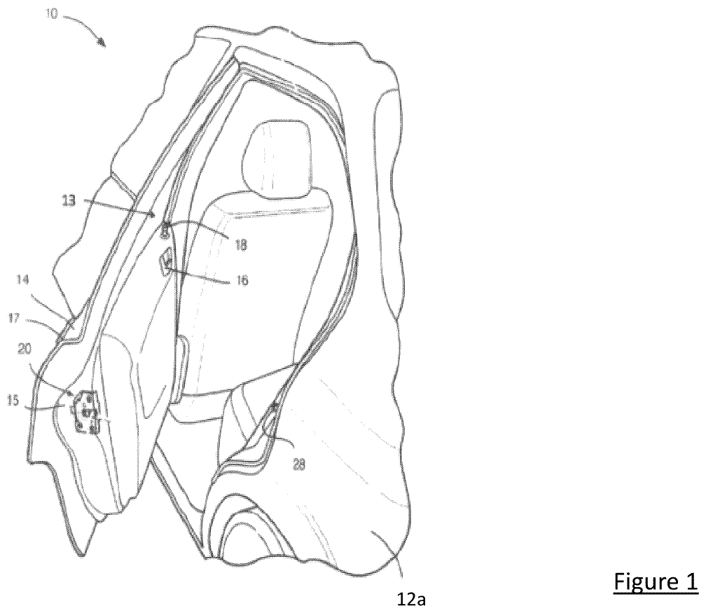

FIG. 1 is a perspective view of a vehicle 10 that includes a vehicle body 12a and at least one vehicle door 14 (also referred to as a closure panel 14). The vehicle closure panel 14 includes a latch 20 that is positioned on a frame 15 of the vehicle closure panel 14, the latch 20 being releasably engageable with a striker 28 on the vehicle body 12 to releasably hold the vehicle closure panel 14 in a closed position. The frame 15 can also support a window 13 via a window regulator assembly mounted to the frame 15 of the vehicle closure panel 14. An outside closure panel handle 17 can be provided for opening the latch 20 (i.e. for releasing the latch 20 from the striker 28) to open the vehicle closure panel 14. Further, the vehicle closure panel 14 can have inside controls 16, 18 (e.g. door handle, door locking/unlocking tab, etc.) for operating the latch 20.

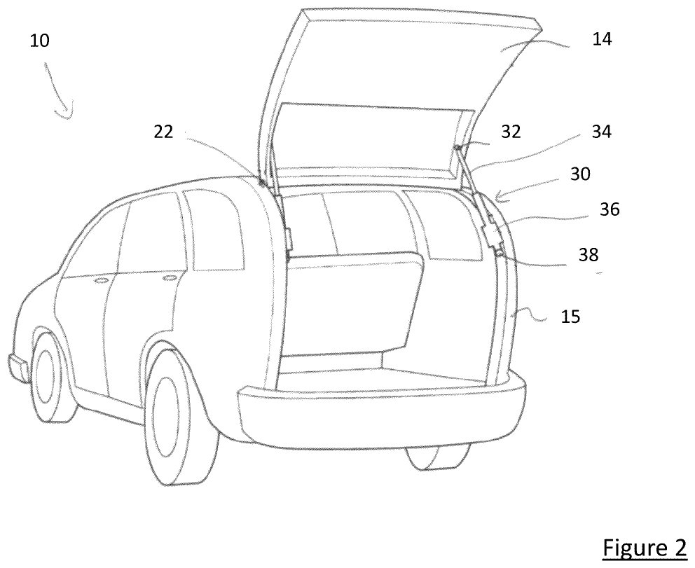

For vehicles 10, the closure panel 14 can be referred to as a partition or door, typically hinged, but sometimes attached by other mechanisms such as tracks, in front of an opening which is used for entering and exiting the vehicle 10 interior by people and/or cargo. In terms of vehicles 10, the closure panel 14 may be a driver/passenger door, a lift gate (see FIG. 2), or it may be some other kind of closure panel 14, such as an upward-swinging vehicle door (i.e. what is sometimes referred to as a gull-wing door) or a conventional type of door that is hinged at a front-facing or back-facing edge of the door, and so allows the door to swing (or slide) away from (or towards) the opening in the vehicle body 12 of the vehicle 10. Also contemplated are sliding door embodiments of the closure panel 14 and canopy door embodiments of the closure panel 14, such that sliding doors can be a type of door that open by sliding horizontally or vertically, whereby the door is either mounted on, or suspended from a track that provides for a larger opening. Canopy doors are a type of door that sits on top of the vehicle 10 and lifts up in some way, to provide access for vehicle passengers via the opening (e.g. car canopy, aircraft canopy, etc.). Canopy doors can be connected (e.g. hinged at a defined pivot axis and/or connected for travel along a track) to the vehicle body 12 of the vehicle at the front, side or back of the door, as the application permits. It is recognized that the vehicle body 12 can be represented as a body panel of the vehicle 10, a frame of the vehicle 10, and/or a combination frame and body panel assembly, as desired.

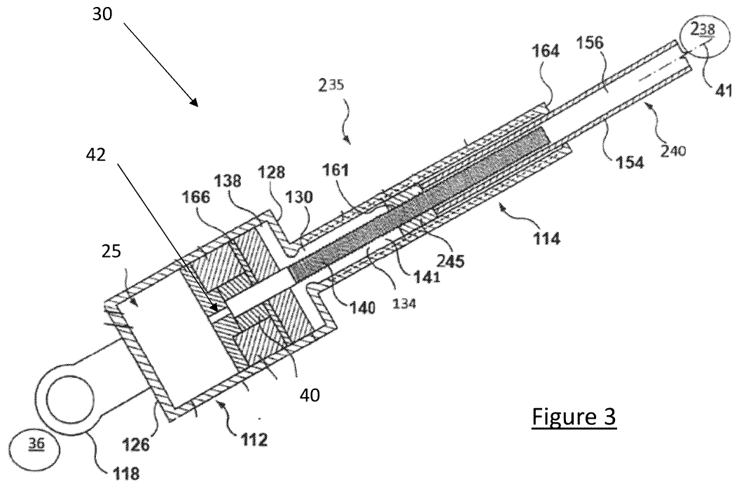

The closure panel 14 (e.g. occupant ingress or egress controlling panels such as but not limited to vehicle doors and lift gates/hatches) can be connected to the vehicle body 12 via one or more hinges 22 (see FIG. 2) and the latch assembly 20 (e.g. for retaining the closure panel 14 in a closed position once closed). Also connecting the closure panel 14 to the frame 15 is an extension mechanism 30 (also referred to as a spindle mechanism or counterbalance mechanism or linear actuator), for example used to provide a counterbalance function during closure panel 14 operation, in order to assist with opening/closing and hold position functions. It is recognized that the extension mechanism 30 can be automated, such as by a motor 25 (see FIG. 3 by example).

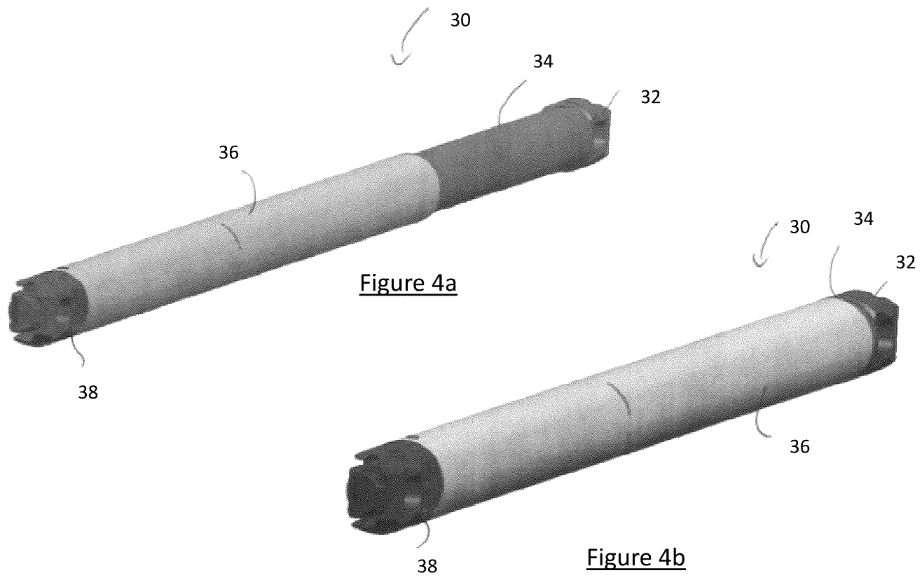

FIG. 3 shows an example configuration for the extension mechanism 30 (e.g. linear actuator, for example a spring loaded strut). A housing 235 (e.g. body housing) contains an extension member 240 (e.g. split lead screw sleeve assembly) used to extend from, or retract within, the housing 235 to effect the resulting location of the closure panel 14 with respect to the doorframe 15. For example, an extended extension member 240 results in positioning the closure panel 14 in the extended state (see FIG. 4a), while a retracted extension member 240 results in positioning the closure panel 14 in a retracted state (see FIG. 4b with respect to the door frame 15). It is recognized that the linear actuator 30 can be implemented as a strut (see FIG. 3 as an example type of strut). The linear actuator 30 can be of a biasing type (e.g. spring and/or gas charge supplying the bias). In one example, see FIG. 3, the extension member 240 is actively driven by via a lead screw 140. The extension member 240 is either extended from, or retracted into, the housing 235. It is recognized that the linear actuator 30 can have the lead screw 140 operated actively (i.e. driven) by a motor 25 (e.g. electrical actuator).

The linear actuator 30 with the body 235 (e.g. housing) has a first end 238 for connecting to pivot point 32 and a second end 36 for connecting to the closure panel 14 at mount 118. In this configuration, the linear actuator 30, by example only, has the extension member 240 (e.g. a stator member slideably engageable with a rotary output member such as via mated threads) positioned in an interior of the housing 235. The extension member 240 is coupled to the lead screw 140 via a travel member 245 (for example as an integral part of or separate to the extension member 240, as an example of the lead screw nut), such that rotation of the lead screw 140 causes travel of the travel member 245 along the lead screw 140, to result in extension or retraction of the extension member 240 with respect to the housing 235. As discussed in relation to FIG. 3, the travel member 245 and the lead screw 140 are coupled to one another via mated threads. As shown, the linear actuator 30 can be a strut having a resilient element of the power spring (not shown) for providing the counterbalance torque during operation of the closure panel 14 in moving between the extended and retracted positions.

Referring again to FIG. 3, the travel member 245 is positioned at one end of the extension member 240. As such, as the extension member 240 is displaced along the longitudinal axis 41, as the attached travel member 245 is displaced along the lead screw 140. As such, as the closure panel 14 is moved between the extended and retracted positions (see FIGS. 4a, 4b), the position of the travel member 245 along the lead screw 140 varies, thereby providing for reciprocation of the travel member 245 along the longitudinal axis 41 of the lead screw 140.

Referring again to FIG. 3, the embodiment of the linear actuator 30 is shown including the housing 235 having a lower housing 112 and an upper housing 114 for containing the extension member 240 (e.g. extensible shaft/rod). The fixed mount 118 is attached to an end wall 126 of lower housing 112 proximal to the door frame 15. Upper housing 114 provides a (e.g. cylindrical) sidewall 141 defining a chamber 134 that is open at both ends. A distal end wall 128 of lower housing 112 includes an aperture 130. The lead screw 140 (or referred to as a lead screw 140 or rotary output member powered by rotary motion of the motor 25) which can be used to transport or otherwise guide the travel member 245 (connected to the extension member 240) along the longitudinal axis 41. For example, the travel member 245 contains an internally facing series of threads in bore 161 that are mated to an externally facing series of threads on the lead screw 140, as desired. Extensible member 240 provides a cylindrical sidewall 154 defining a chamber 156 and can be concentrically mounted between upper housing 114 and lead screw 140. As described earlier, pivot mount 238 (i.e. pivot point 32) is attached to the distal end of extensible member 240. The nut 245 (also referred to as the travel member 245 or screw nut is mounted around the proximal end of extensible member 240 relative to lower housing 112 and is coupled with lead screw 140 in order to convert the rotational movement of lead screw 140 into the linear motion of the extensible member 240 along the longitudinal axis 41 of lead screw 140. The nut 245 can include splines that extend into opposing coaxial slots provided on the inside of upper housing 114 to inhibit nut 245 from rotating as the nut 245 travels along the longitudinal axis 41. Alternatively, the nut 245 may be configured without the splines and thus be free to rotate as the nut 245 travels along the longitudinal axis 41, without departing from the scope of the description. An integrally-formed outer lip 164 in upper housing 114 can provide an environmental seal between chamber 134 and the outside.

An optional spring housing 138 can be provided in lower housing 112 and defined by cylindrical sidewall 122, end wall 128, and a flange 166. Within spring housing 138, a power spring (not shown in FIG. 3) similar to the power spring can be optionally coiled around lead screw 140, providing a mechanical counterbalance to the weight of the closure panel 14. One end of the optional power spring can be positioned or otherwise attached to the travel member 245 and the other is secured to a portion of cylindrical sidewall.

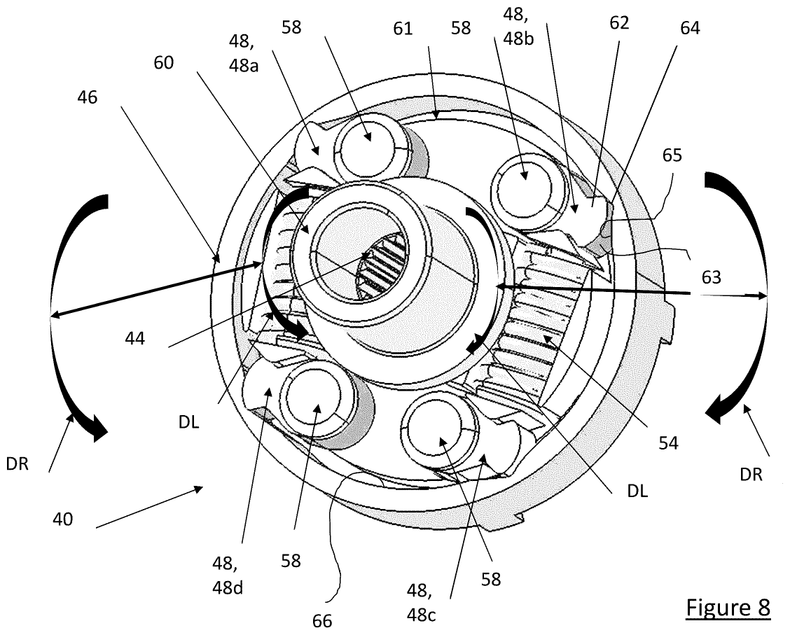

Referring again to FIG. 3, a clutch mechanism 40 can be positioned between the motor 24 and the lead screw 140, in order to facilitate transmission (e.g. couple) of rotary power between a shaft 42 of the motor 25 and the lead screw 140. Further, the clutch mechanism 40 can be used to inhibit transmission (e.g. decouple) of rotary power between the shaft 42 of the motor 25 and the lead screw 140, as further described below. In particular, the clutch mechanism 40 can be used to inhibit decoupling of a pawl body 50 from a ratchet 46 in a first rotation direction by a first set of a plurality of pawls 48; inhibiting decoupling of the pawl body 50 from the ratchet 46 in a second rotation direction, such that the second rotation direction is opposite to the first rotation direction. Further, each of the pawls 48 has a corresponding lobe 62 for engaging with an adjacent notch 64 in a surface 66 (e.g. inside surface) of the ratchet 46, when the ratchet 46 is engaged with the pawl body 50, as shown in FIG. 8.

Referring to FIGS. 4a, 4b, the extension mechanism 30 has a first pivot connection 32 (e.g. end fitting connection) at one end for connecting the extension mechanism 30 to the closure panel 14 and a second pivot connection 38 (e.g. end fitting connection) for pivotally connecting the extension mechanism 30 to the frame 15. Typically, the extension mechanism 30 includes an extension member 34 (e.g. as part of an inner tube — see tube 240 as described above) housed in a body housing 36 (e.g. also referred to as housing 235), such that the extension member 34 extends out of (and retracts in to) the body 36 as the closure panel 14 is opened and closed. For example, the extension mechanism 30 can be passively operated (i.e. follows movement of the closure panel 14) and/or actively operated (i.e. mechanically or electrically actuated and thus driving movement of the closure panel). Referring to FIG. 4a, shown is an embodiment of the extension mechanism 30 in an extended state and in FIG. 4b a retracted state.

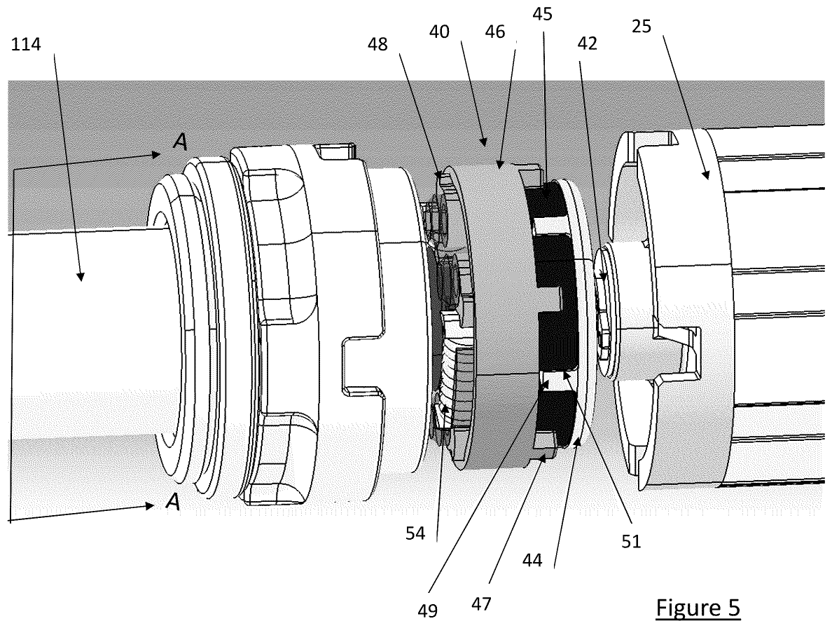

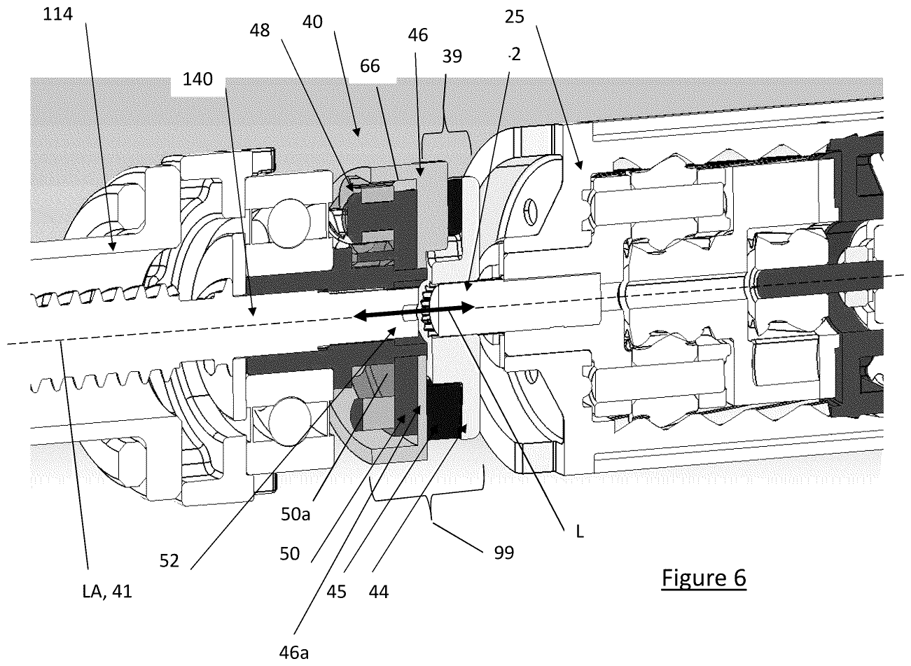

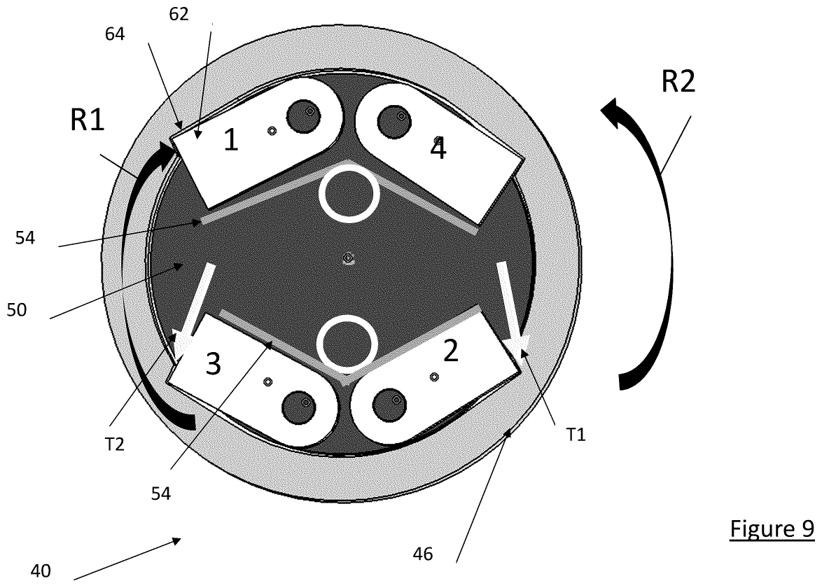

Referring to FIG. 5, shown is an exterior view of the extension mechanism 30 with the clutch mechanism 40 positioned between the motor 25 (e.g. actuator) and the lead screw 140 (not shown) within the housing portion 114, such that a connection element 44 is used to couple the shaft 42 of the motor 25 to a ratchet 46 (see FIG. 6) of the clutch mechanism 40, via a plurality of pawls 48. Referring to FIG. 6, shown is a cross sectional view of the clutch mechanism 40, including the plurality of pawls 48 pivotally mounted to a circular disc or plate 50a, also referred to as a first clutch plate, used to releasably couple the ratchet 46 to the pawl body 50 (which is connected to an end 52 of the lead screw 140). As such, with the pawls 48 engaged with the ratchet 46, as further described below, the driven connection element 44 (connected to the shaft 42) drives rotation of the lead screw 140 via the ratchet 46. Alternatively, with the pawls 48 disengaged with the ratchet 46, as further described below, the driven connection element 44 (connected to the shaft 42) is inhibited from driving rotation of the lead screw 140, as the pawl body 50 is disengaged from the ratchet 46 and thus the connection element 44 (attached to the shaft 42). Also shown are resilient elements (e.g. springs) 54, which are mounted on the pawl body 50 and used to bias the pawls 48 into engagement with the ratchet 46. Illustratively, as shown in FIGS. 8, the springs 54 are shown as each a coil spring is positioned between a pair of pawls and thus a respective spring 54 may act to bias both two pawls simultaneously, for example one spring 54 acts between pawl 48a and 48b, as well another spring 54 acts between pawl 48c and 48d of FIG. 8, and similarly one spring is provided between pawl 1 and 4, as well as between pawl 2 and 3 of FIG. 9. Thus when one of the pawls 48 is urged away from the ratchet 46, the bias force from the spring 54 may increase for both of the pawls 48 e.g. 48a, 48d.

As such, during disengagement of the pawls 48 from the ratchet 46, advantageously any continued rotation of the shaft 25 would not be able to (e.g. appreciably) drive the lead screw 140, which is desired in cases where the closure panel 14 is blocked from the configured full range of travel (e.g. due to the unexpected presence of a foreign object inhibiting travel of the closure panel 14 to the closed position). Once the pawls 48 are disengaged from the ratchet 46, it is considered that the motor 25 is decoupled from the lead screw 140.

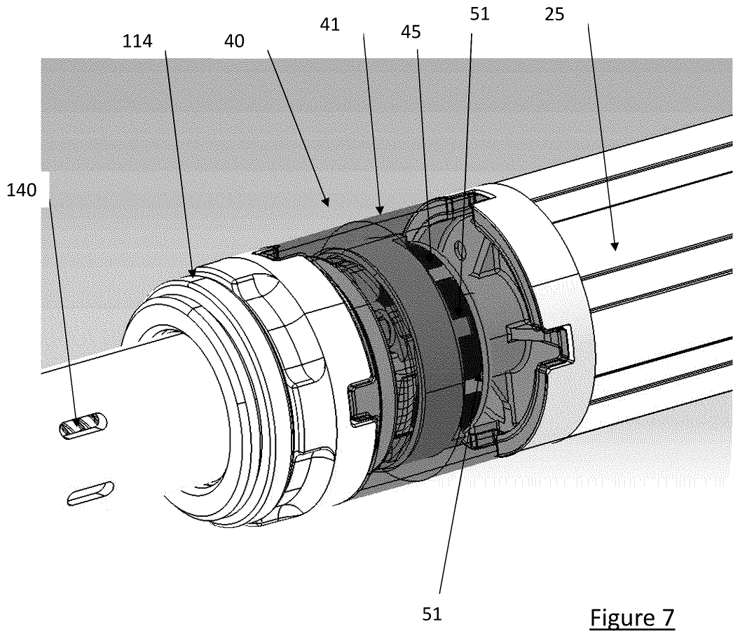

Referring again to FIGS. 5, 7, shown is a housing 41 of the clutch mechanism 40, such that the ratchet 46 and connection element 44 are free to rotate within the housing 41. Connection element 44 and ratchet 46 are coupled together using a vibration dampener 39 having for example a layer of vibration dampening or vibration absorbing material 45, such as rubber or semi-rigid plastic for example. Connection element 44 and ratchet 46 may each have a plurality of radially distributed extending tabs 47, 49 for engaging radially offset slots 51 formed in the vibration absorbing material 45. The configuration of connection element 44 and ratchet 46 together as a clutch unit for coupling the motor 25 with the lead screw 140 provides a compact radial disengagement type clutch and shock absorber without adding overall dead length to the spindle 30 along the longitudinal axis LA due to the overlapping constructions of the clutch mechanism 40 and vibration dampener 39. The shock absorber layer 45 can be constructed with less longitudinal thickness due to the pawls 48 camming out of notches 64 before the shear forces on shock absorber layer 45 from radially distributed extending tabs 47, 49 are limited when the clutch disengages. As a result, a compact clutch and shock absorbing unit 99 having a length L that does not require additional extension of the spindle 40 along its longitudinal axis LA is provided. Referring to FIG. 8, shown is an internal view of the clutch mechanism 40, with ratchet 46, pawl body 52, biasing element(s) 54 and the plurality of pawls 48 mounted on the pawl body 52 by respective pivot connections 58. Also shown by example is the connection element 44 (e.g. splines) for connecting the ratchet 46 to the shaft 25 (see FIG. 5) and a connection element 60 (e.g. sleeve) for connecting to the end 52 of the lead screw 140 (see FIG. 5). Further, each of the pawls 48 has a corresponding lobe 62 for engaging with an adjacent notch 64 in a surface 66 (e.g. inside surface) of the ratchet 46, when the ratchet 46 is engaged with the pawl body 50, as shown in FIG. 8. When engaged, the driven rotation DR of the ratchet 46 (e.g. in either direction as a bidirectional clutch mechanism 40) provides for corresponding driven rotation DL of the lead screw 140 (e.g. connected to the connection element 60). As shown by example, the lobe 62 has a first cam surface 63 and the adjacent notch 64 has a second cam surface 65, such that during normal operation (e.g. absent any induced shocks to the static frictional connection between the surfaces 63, 65 due to any unexpected stopping or slowdown of the closure panel 14 travel—e.g. due to the presence of a foreign object blocking travel of the closure panel 14) of the clutch mechanism 40 the static friction between the surfaces 63, 65 helps to retain the lobe 62 engaged with the notch 64.

Alternatively, in the event of an unexpected stress applied to the surfaces 63, 65 (e.g. force T such as a shear or torque force applied between the surfaces 63, 65) due to an unexpected slowdown or stoppage of the closure panel 14 travel (as driven by the motor 25), the surfaces 63, 65 would slip (e.g. move) relative to one another in order to overcome the bias of the resilient element 54 providing the bias used to maintain the static friction between the surfaces 63, 65. In FIG. 9, shown is a situation of the clutch mechanism 40 in which the motor 25 stalls and pushes on pawls 1 and 2, thus applying a force T1.

An example of the applied force T1 is shown in FIG. 9, such that the force T1 applied to the pawls 1 and 2 (normally facilitating resistance to relative movement—e.g. rotation R1—between the pawl body 52 and the ratchet 46 during normal operation of the clutch mechanism 40) overcomes the friction (e.g. static) between the surfaces 63, 65 and this causes relative movement between the ratchet 46 and the pawl body 52, thus resulting in dislodgement of the lobes 62 from their notches 64. This relative movement can reduce the friction between the surfaces 63, 65 (e.g. turning static into sliding friction there between) and thus the ratchet 46 is free to begin rotation about the pawl body 52, in the direction R1, thus effectively decoupling the motor 25 from the lead screw 140 (see FIG. 6).

Alternatively, an example of the applied force T2 is shown in FIG. 9, such that the force T2 applied to the pawls 3 and 4 (normally facilitating resistance to relative movement—e.g. rotation R2—between the pawl body 52 and the ratchet 46 during normal operation of the clutch mechanism 40) overcomes the friction (e.g. static) between the surfaces 63, 65 and this causes relative movement between the ratchet 46 and the pawl body 52, thus resulting in dislodgement of the lobes 62 from their notches 64. This relative movement can reduce the friction between the surfaces 63, 65 (e.g. turning static into sliding friction there between) and thus the ratchet 46 is free to begin rotation about the pawl body 52, in direction R2, thus effectively decoupling the motor 25 from the lead screw 140 (see FIG. 6).

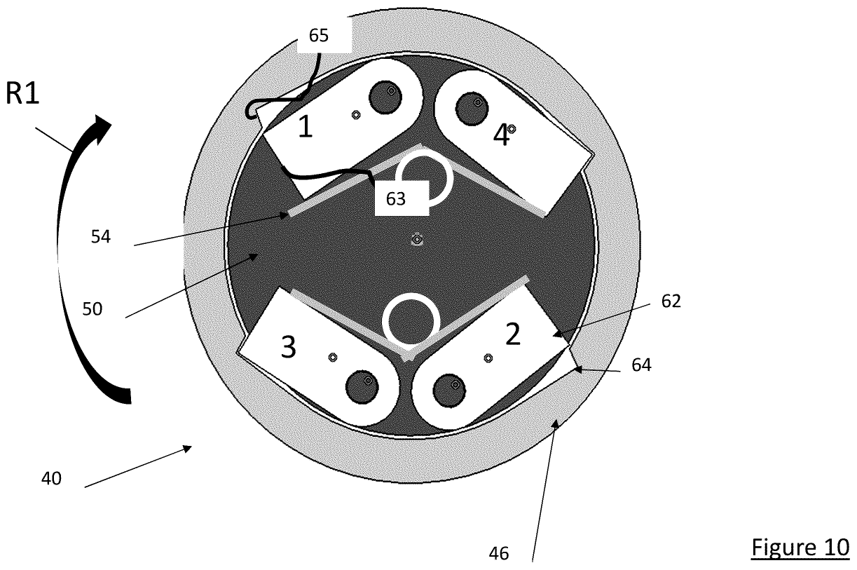

Shown in FIG. 10 is an example of the result of force T1, thus overcoming the friction (e.g. static) between the surfaces 63, 65 of the pawls 1,2 and this causes relative movement between the ratchet 46 and the pawl body 52, thus resulting in dislodgement of the lobes 62 from their notches 64. Thus as shown, pawls 1 and 2 rotate counter clockwise pushing the springs 54 and the motor 25 can then rotate without transmitting the motion to the pawl body 50 of the ratchet 46 (due to disengagement of the pals 1,2).

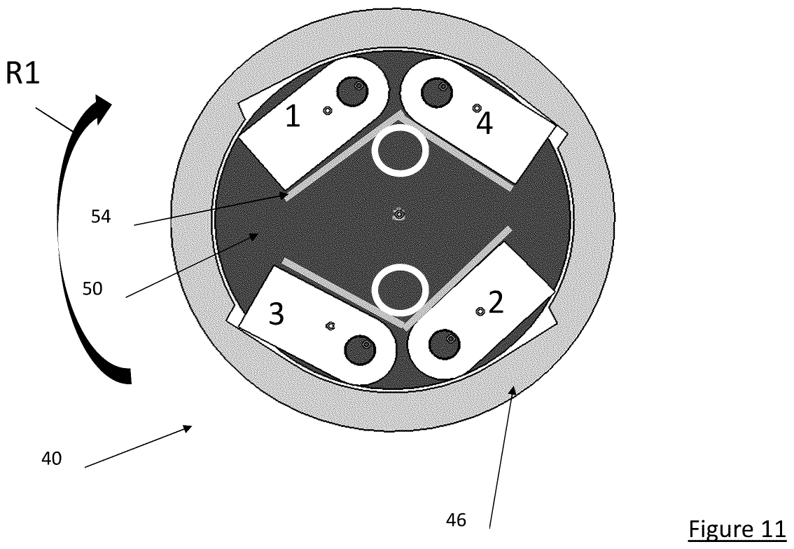

Referring to FIG. 11, shown is where the continued relative rotation R1 between the ratchet 46 and the pawl body 50 causes disengagement of all of the pawls 1,2,3,4 from the ratchet 46. Clutch mechanism 40 is temporarily in a fully disengaged state where some free rotation of the ratchet 46 and the pawl body 50 may occur. Friction forces of the pawls 1, 2, 3, 4 acting on the inner radial surface of the ratchet 46 connecting notches 64, 65 may occur to cause some temporary resistance to relative rotation of the ratchet 46 and the pawl body 50 when pawls 1, 2, 3, are disengaged from notches 64, 65. Clutch mechanism 40 will remain temporarily in a fully disengaged state until one or more pawls 1, 2, 3, 4 engage with one or more notches 64 in either a partially engaged tate if less than the total number of pawls engages each a notch 64 or a fully engaged state if all of the pawls 1, 2, 3, 4 engage all of the notches 64. In this manner, the lead screw 140 can be protected from undue stresses applied to the clutch mechanism 40 by the motor 25, as a result of the force T1, T2 being generated in the presence of the unexpected event (e.g. presence of a foreign object) during assisted movement of the closure panel 14 by the actuated spindle mechanism 30 (e.g. extension mechanism 30). Thus, due to the shape of the surface 63 of the lobes 62, the pawls 3 and 4 also follow the internal surface 66 (see FIG. 8) shape of the ratchet 46 extending from a circular clutch plate or disc 46a, also referred to as a first clutch plate, and the entire clutch mechanism 40 system rotates without transmission of the rotary motion of the shaft 42 to the linear screw 140. Pawls 1,2,3,4 are shown as nested within the internal circular surface 66 of the ratchet 46.

It is recognized that a sensor (not shown) can be used to detect the relative movement R1, R2 and thus stop the motor 25. Upon restart of the motor 25, e.g. once the foreign object is removed, the bias of the biasing element 54 can be used to reestablish engagement between the lobes 62 and notches 64, thus recoupling the pawl body 50 to the ratchet 46 (thus coupling once again the motor 25 to the lead screw 140).

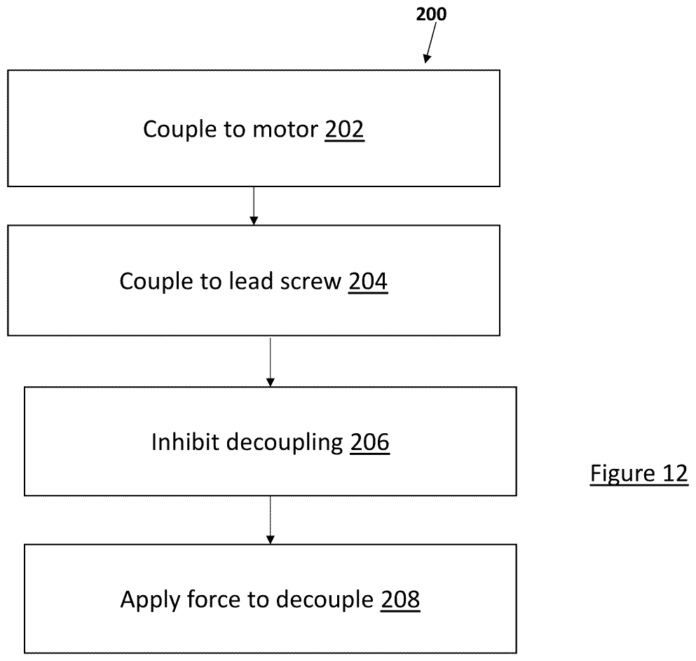

Referring to FIG. 12, shown is an example operation 200 of the clutch mechanism 40 as described above. At step 202 coupling the clutch mechanism 40 to a motor shaft 42; at step 204 coupling the clutch mechanism 40 to a driven element 140; at step 206 inhibiting decoupling of the pawl body 50 from the ratchet 46 in a first rotation direction R1 by a first set of a plurality of pawls 1,2; at step 206 inhibiting decoupling of the pawl body 50 from the ratchet 46 in a second rotation direction R2, such that the second rotation direction R2 is opposite to the first rotation direction R1. Further, at step 208 applying a force T1, T2 between the respective lobe 62 and the respective one of the notches 64 in order to overcome friction present between the respective lobe 62 and the respective one of the notches 64, whereby relative movement between the ratchet 46 and the pawl body 50 is facilitated.

In view of the above, the clutch mechanism 40 can comprise: a first connection 44 for coupling the clutch mechanism 40 to the motor shaft 42; a second connection 60 for coupling the clutch mechanism 40 to the driven element 140; a ratchet 46 having a plurality of notches 64; a pawl body 50 having pivotally mounted thereon a plurality of pawls 48; each of the plurality of pawls 48 having a respective lobe 62 for engaging with a respective one of the plurality of notches 64; and one or more resilient elements 54 for biasing the plurality of pawls into engagement with the plurality of notches; wherein a first set (e.g. one or more pawls 1,2) of the plurality of pawls 48 inhibits decoupling of the pawl body 50 from the ratchet 46 in a first rotation direction R1 and a second set (e.g. one or more pawls 3,4) of the plurality of pawls48 inhibits decoupling of the pawl body 50 from the ratchet 46 in a second rotation direction R2, such that the second rotation direction R2 is opposite to the first rotation direction R1 (e.g. about a rotational axis of the shaft 42). As such, contrary to what is shown in FIG. 8, each set of pawls 48 can consist of a single pawl 1 and 3 respectively, a pair of pawls 1,2 and 3,4, or more as desired.

In the above, it is recognized that the respective lobe 62 of each of the plurality of pawls 48 has a cam surface 63 engaged with a corresponding surface 65 of the respective notch 64 adjacent to the respective lobe 62, such that biased contact between the surfaces 63, 65 generates friction sufficient to retain normal engagement between the surfaces 63, 65 during operation of the motor 42. For example, the corresponding surface 65 of the notch 64 can be oriented (e.g. inclined) with respect to the cam surface 63 in order to facilitate relative movement between the surfaces 63,65 upon application of an applied force T1, T2 between the respective lobe 62 and the respective notch 64, as driven by the motor 25. Surfaces 63, 65 can be configured for providing the friction sufficient to retain normal engagement of the surfaces 63, 65 below a torque value applied to the clutch mechanism 40, and be configured for providing the friction sufficient to allow disengagement or slip of the surfaces 63, 65 relative to one another above a torque applied to the clutch mechanism 40. For example, the angles of the surfaces 63, 65 may be accordingly configured (more sloped, less sloped), and/or the length of the surfaces 63, 65 may be accordingly configured, and/or the shape of the surfaces 63, 65 may be configured accordingly and as desired. Therefore, the slip torque can be selected by configuring the surfaces 63, 65.

As shown, the pawl body 50 is shown such that the ratchet 46 has an inside surface 66 for the plurality of notches 64, such that the pawl body 50 is positioned in an interior 61 of the ratchet 46. However, it is recognized that the pawl body 50 could be positioned on an exterior of the ratchet 46, as desired. The first connection 44 is mounted on the ratchet 46 and the second connection 60 is mounted on the pawl body 50, however the opposite could also be contemplated.

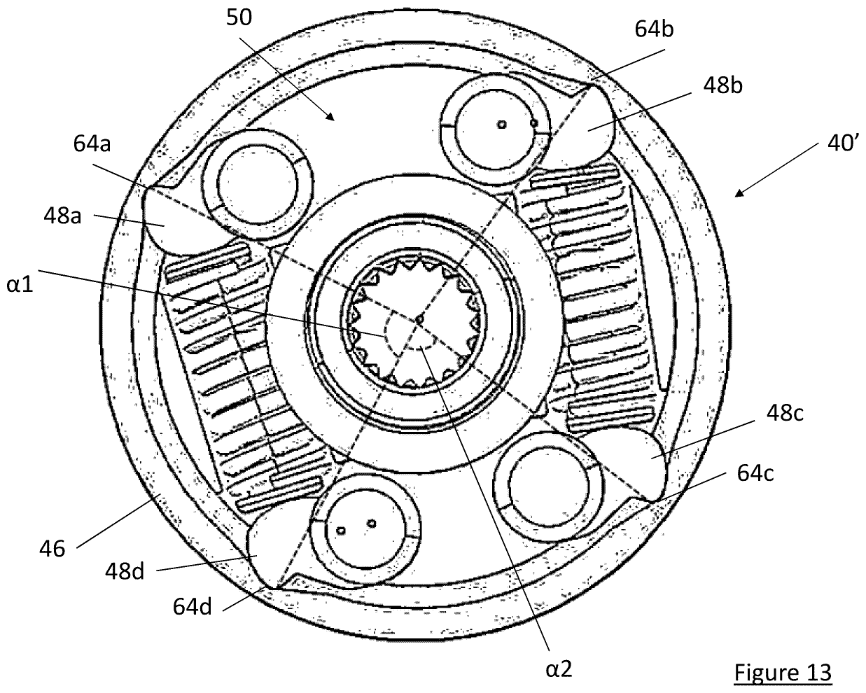

Now with further reference to FIG. 13, illustrated in accordance with another configuration of clutch mechanism 40′ is an asymmetrical clutch mechanism 40′. Illustratively, notches 64a, 64b, 64c, 64d are unevenly distributed on the ratchet 46 as shown by different angles α1 and α2 from the center of the clutch mechanism 40′ to similar points of the notches 64a, 64b, 64c, 64d not being perpendicular or at 90 degrees offset from one another as would be for a symmetrical or even distribution of the notches 64a, 64b, 64c, 64d. In other words, the notches 64a, 64b, 64c, 64d are not equally radially distributed along the ratchet 46. It is understood that in another possible configuration, notches 64a, 64b, 64c, 64d may be evenly distributed on ratchet 46 and rather pawls 48 may be positioned about non-symmetrically positioned pivot axis and/or different lengths of pawls 48a, 48b, 48c, 48d may be provided to configure the clutch mechanism 40′ as an asymmetrical clutch.

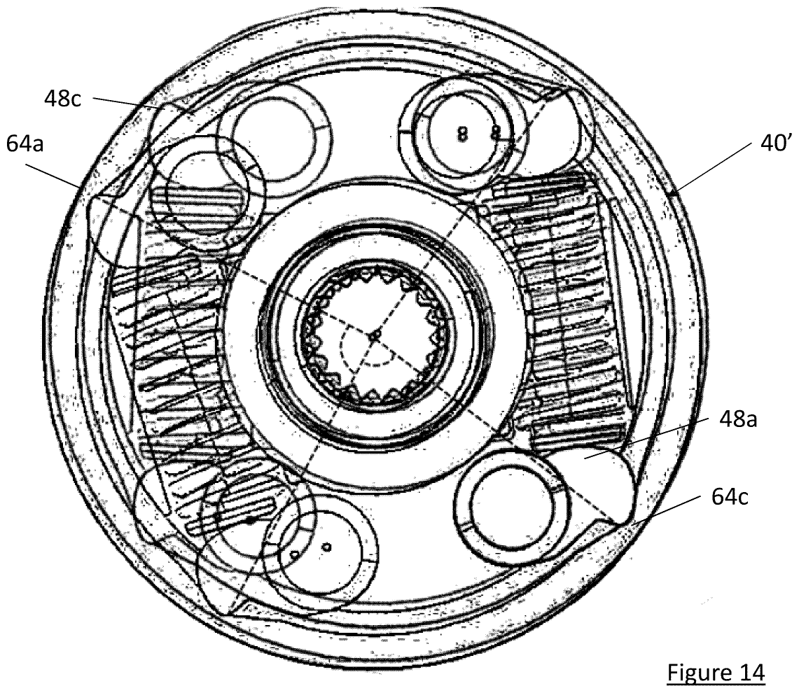

Clutch mechanism 40′ provides for the reengagement of all of the pawls 48a, 48b, 48c, 48d with initially engaged notches 64a, 64b, 64c, 64d as shown in FIG. 13 only after the ratchet 46 and the pawl body 50 have rotated a full 360 degrees, or upon a full rotation between ratchet 46 and pawl body 50. Prior to a full rotation between ratchet 46 and pawl body 50 the clutch mechanism 40′ is in a partially disengaged state and may have less than all the pawls 48a, 48b, 48c, 48d engaging with less than all of the notches 64a, 64b, 64c, 64d for any given angular rotation of the ratchet 46 relative to the pawl body 50. For example as shown in FIG. 14, showing that upon a half turn (180 degrees) clockwise rotation of the pawl body 50, pawl 48a is shown engaged with notch 64c while pawl 48c is not engaged with notch 64a, with pawl 48c having already reengaged with notch 64a approximately −5 degrees rotation at which position pawl 48a would have not yet has reengaged with notch 64c. FIG. 14 shows an overlapping view of the pawl body 50 in two positions. Thus during less than a full rotation the between ratchet 46 and pawl body 50, less than all of the pawls 48a, 48b, 48c, 48d are simultaneously engaged with all of the notches 64a, 64b, 64c, 64d. Only a further continued half turn rotation of the ratchet 46 and pawl body 50 in the clockwise direction from the state shown in FIG. 14 will cause the all of the pawls 48a, 48b, 48c, 48d to eventually simultaneously engage with all of the notches 64a, 64b, 64c, 64d once a full rotation is reached at state as shown again in FIG. 13. Thus illustratively, initially two pawls 48a and 48c each fully engaged with a notch are providing the resistance to maintain the clutch in a fully engaged position against a clockwise rotation of the ratchet 46 from a position shown in FIG. 13, and thereafter a single pawl 48a fully reengaged with a notch may provide the resistance to maintain the clutch 40′ in a partially engaged position. Note, pawls 48a and 48c initially being cammed out of notches 64a, 64c from a position shown in FIG. 13 may have the most influence when the ratchet 46 and pawl body 50 are rotated in the clockwise direction as described herein above and may in one possible configuration be considered as all of the pawls acting against a full clutch disengagement when rotated in one direction, with alignment of other pawls 48b, 48d having the most influence when the ratchet 46 and pawl body 50 are rotated in the counterclockwise clockwise direction from a position shown in FIG. 13 and be considered as all of the pawls acting against a full clutch disengagement when rotated in the counterclockwise clockwise direction, pawls 48a and 48c engaging and disengaing notches 64b, 64d having reversed shaped notches compared to notches 64a 64c may have a lessor resistive effect if pawls 48a and 48c are sized engaging and disengaing notches 64b, 64d during a clockwise rotation of the ratchet 46 relative to the pawl body 50. A similar effect may occur for pawls 48b, 48c and notches 64a, 64c during a clockwise rotation from a position shown in FIG. 13 during rotation of the ratchet 46 relative to the pawl body 50. As a result during a partial disengaged state of the clutch mechanism 40′ subsequent the clutch mechanism 40′ being transitioned from the fully engaged state after having a slip torque value influenced by the pawls 48a, 48b, 48c, 48d exceeded, the disengagement torque of the clutch mechanism 40′ is less than the disengagement torque in the fully engaged state due to less than all the pawls 48 able to fully reengage with less than all the notches 64. As a result, sound or clicks produced during clutch activation e.g. due to pawls 48 being reengaged with a notch 64 may be reduced due to the reduction in simultaneous reengagement of pawls 48 with notches 64. Furthermore, shock and vibration may be reduced after the initial clutch disengagement since before a full rotation of the pawl body 50 and ratchet 46 occurs, a lower number of pawls 48 may engage and disengage notches 64 until relative motion between pawl body 50 and ratchet 46 ceases e.g. until motor 25 momentum is dissipated after motor 25 deactivation, preventing more abrupt deceleration of the components while still allowing a reduction in energy due to the camming action and spring 54 compression occurring during the lower number of pawls 48 engaging and disengaging notches 64. Thus a clutch mechanism 40′ having a variable slip torque depending on a radial position after full disengagement is provided, where the slip torque following an initial disengagement of the clutch is lower than the slip torque first required to disengaged the clutch 40′. It is recognized that other degrees of rotation may be provided prior to a full reengagement of the clutch mechanism 40′ other than at 360 degrees, such as at % rotation or 1¼ rotation following an initially disengagement in either first or second directions, as examples, which may be selected through the orientation and number of the pawls 48 relative to notches 64 as desired.

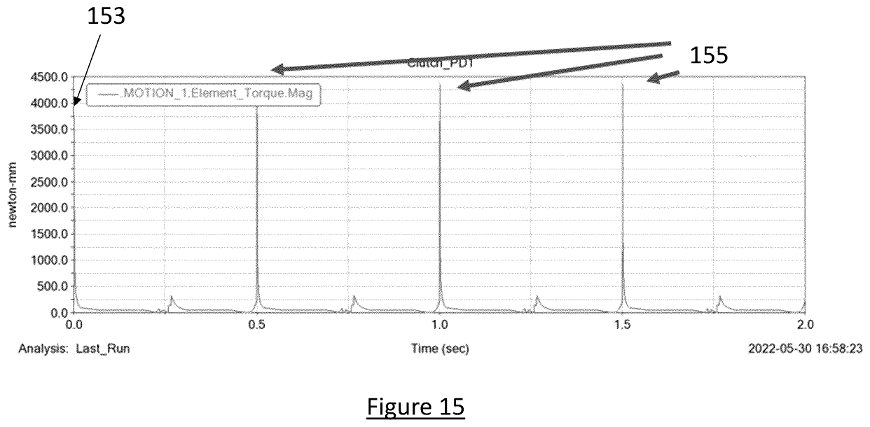

As shown in FIG. 15, for configuration of a symmetrical clutch mechanism 40, the disengagement torque values of the clutch mechanism 40 are equal at each reengagement of the pawls 48a, 48b, 48c, 48d which are simultaneously engaged with all of the notches 64a, 64b, 64c, 64d to fully couple the ratchet 46 with the pawl body 50. Thus for example following the clutch mechanism 40 initial disengagement at an initial slip torque value 153, three subsequent reengagements and disengagements represented by the three spikes in FIG. 15 may occur according to one possible scenario before the relative motion between pawl body 50 and ratchet 46 ceases or lacks the rotational energy to cause a 5th disengagement. As shown in FIG. 15, for configuration of a symmetrical clutch mechanism 40, the overall disengagement or slipping torque values 155 of the clutch mechanism 40 are equal (shown as approx. 4250 N-mm) at each reengagement of the pawls 48a, 48b, 48c, 48d are simultaneously engaged with all of the notches 64a, 64b, 64c, 64d, as well as equal to the initial slip torque value 153. Thus for example following the clutch mechanism 40 initial disengagement, three subsequent reengagements and disengagements may occur before the relative motion between pawl body 50 and ratchet 46 ceases or is reduced to be insufficient to cause a fifth disengagement. Should energy remain in the system that is however insufficient to cause the disengagement of the clutch mechanism 40, following the fifth disengagement, energy will be transmitted to other components as shock when the pawls 48a, 48b, 48c, 48d are unable to be cammed out of engagement with all of the notches 64a, 64b, 64c, 64d simultaneously.

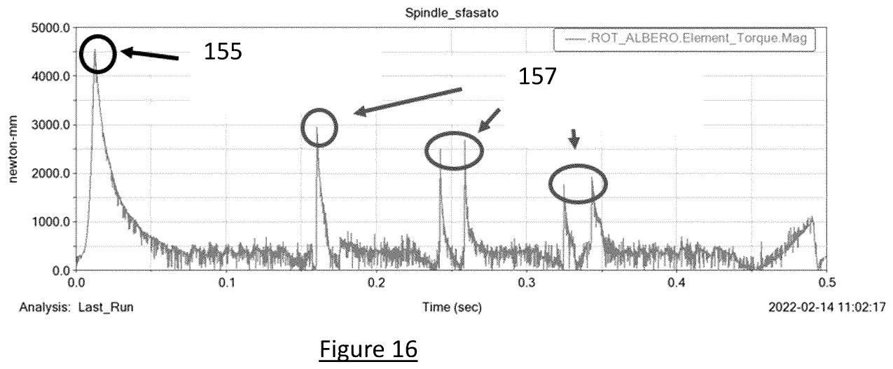

As shown in FIG. 16, for the configuration of an asymmetrical clutch mechanism 40′, the initial disengagement torque value 155 of the clutch mechanism 40′ required for an initial disengagement or for a decoupling of the pawls 48a, 48c simultaneously engaged with the notches 64a, 64c is shown. Thus for example following the clutch mechanism 40′ initial disengagement when the slip torque value applied clockwise to the clutch mechanism 40′ in FIG. 13 exceeds 4500N-mm causing pawls 48a, 48c to simultaneously disengage with the notches 64a, 64c, five subsequent reengagements and disengagements may occur before the relative motion between pawl body 50 and ratchet 46 ceases, where at the radial positions of the pawls and notches during a partially disengaged state relative to result in a lower disengagement slip torque value 157 than the initial disengagement torque value 155 due to less than all the pawls 48 engaging with all the notches 64 at a given angular rotation whereat the ratchet 46 is partially coupled the pawl body 50. Thus energy may be less-abruptly dissipated reducing shock and less sound may be generated following an initial clutch disengagement due to a lower number of pawls acting during the disengaged clutch state mitigating the noise which may be noticeable to a user of the vehicle.

The preceding example embodiments of the present disclosure are merely used for clearly illustrating the present disclosure and are not intended to limit implementations of the present disclosure. Those of ordinary skill in the art can make various apparent modifications, adaptations, and substitutions without departing from the scope of the present disclosure. The implementations of the present disclosure cannot be and do not need to be all exhausted herein. Any modifications, equivalent substitutions, improvements, and the like made within the spirit and principle of the present disclosure are within the scope of the claims of the present disclosure.

What is claimed is:

1. A clutch mechanism, comprising:
a first connection for coupling the clutch mechanism to a motor shaft;
a second connection for coupling the clutch mechanism to a driven element;
a ratchet having a plurality of notches;
a pawl body having pivotally mounted thereon a plurality of pawls;
each of the plurality of pawls having a respective lobe for engaging with a respective one of the plurality of notches; and
one or more resilient elements for biasing the plurality of pawls into engagement with the plurality of notches;
wherein a first set of the plurality of pawls inhibits decoupling of the pawl body from the ratchet in a first rotation direction and a second set of the plurality of pawls inhibits decoupling of the pawl body from the ratchet in a second rotation direction, such that the second rotation direction is opposite to the first rotation direction.

2. The mechanism of claim 1, wherein the driven element is a lead screw of an extension mechanism used for coupling a closure panel to a body of a vehicle.

3. The mechanism of claim 1, wherein the respective lobe of each of the plurality of pawls has a cam surface engaged with a corresponding surface of the respective notch adjacent to the respective lobe, such that biased contact between the surfaces generates friction sufficient to retain engagement between the surfaces during operation of the motor shaft.

4. The mechanism of claim 3, wherein the corresponding surface of the notch is oriented with respect to the cam surface in order to facilitate relative movement between the surfaces upon application of an applied force between the respective lobe and the respective notch, as driven by the motor shaft.

5. The mechanism of claim 4, wherein the applied force results in overcoming the friction in order to overcome the biased contact and move the respective lobe out of engagement with the respective notch.

6. The mechanism of claim 1, wherein the first set includes a pair of first pawls to resist relative movement between the pawl body and the ratchet in the first rotation direction and the second set includes a second pair of pawls to resists relative movement between the pawl body and the ratchet in the second rotation direction.

7. The mechanism of claim 1, wherein the ratchet has an inside surface for the plurality of notches, such that the pawl body is positioned in an interior of the ratchet.

8. The mechanism of claim 1, wherein the first connection is mounted on the ratchet and the second connection is mounted on the pawl body.

9. The mechanism of claim 1, wherein the closure pane is a liftgate of the vehicle.

10. The mechanism of claim 1, wherein the notches are unevenly distributed on the ratchet.

11. The mechanism of claim 1, wherein subsequent a decoupling of the pawl body from the ratchet, the pawl body and the ratchet are fully recoupled upon a full rotation of the pawl body relative to the ratchet.

12. The mechanism of claim 1, wherein the first set of the plurality of pawls comprises at least two pawls and the second set of the plurality of pawls comprises at least two pawls, wherein each of the pawls is in engagement with one of the plurality of notches when the pawl body is fully coupled with the ratchet, and wherein at least one of the pawls of the first set and the second set is in engagement with at least one of the plurality of notches when the pawl body is partially coupled with the ratchet.

13. The mechanism of claim 12, wherein subsequent to an initial disengagement of each of the pawls of the first set of the plurality of pawls and the second set of plurality of pawls, all of the pawls of the first set of the plurality of pawls and the second set of plurality of pawls reengage with the plurality of notches upon a full rotation of the pawl body relative to the ratchet.

14. A method of operating a clutch, the method comprising the steps of:
coupling the clutch mechanism to a motor shaft;
coupling the clutch mechanism to a driven element;
inhibiting decoupling of a pawl body from a ratchet in a first rotation direction by a first set of a plurality of pawls;
inhibiting decoupling of the pawl body from the ratchet in a second rotation direction, such that the second rotation direction is opposite to the first rotation direction.

15. The method of claim 14, wherein ratchet has a plurality of notches, the pawl body has pivotally mounted thereon the plurality of pawls, each of the plurality of pawls has a respective lobe for engaging with a respective one of the plurality of notches, and one or more resilient elements bias the plurality of pawls into engagement with the plurality of notches.

16. The method of claim 15 further comprising applying a force between the respective lobe and the respective one of the notches in order to overcome friction present between the respective lobe and the respective one of the notches, whereby relative movement between the ratchet and the pawl body is facilitated.

17. A spindle mechanism for a motor vehicle, the spindle mechanism comprising:
an extension member having an extended position and a retracted position;
a motor having a motor shaft, the motor for moving the extension member between an extended position and the retracted position;
a clutch mechanism positioned between the extension member and the motor, wherein the clutch mechanism comprises a fully engaged state, a partially engaged state, and a fully disengaged state, wherein the torque required to transition the clutch mechanism from the fully engaged state to the fully disengaged state is higher than the torque required to transition the clutch mechanism from the partially engaged state to the fully disengaged state.

18. The spindle mechanism of claim 17, wherein the clutch mechanism comprises a first clutch plate and a second clutch plate, the first and second clutch plates are adapted to rotate conjointly when the clutch mechanism is in the fully engaged state and are adapted to rotate separately when the clutch mechanism is in the partially engaged state, wherein the first clutch plate and a second clutch plate return to the fully engaged state upon a full rotation of first clutch plate relative to the second clutch plate.

19. The spindle mechanism of claim 17, comprising a plurality of pawls each engageable with and disengageable a plurality of ratchet notches, wherein in the fully engaged state to the partially engaged state all of the pawls are engaged with the plurality of ratchet notches and in the partially engaged state less that all the pawls are engaged with the plurality of notches.
